(19) United States
(12) Patent Application Publication
(10) Pub. No.: US 2021/0209486 A1
(43) Pub. Date: Jul. 8, 2021

(54) SYSTEM AND METHOD FOR ANOMALY DETECTION FOR TIME SERIES DATA

(71) Applicant: Intuit Inc., Mountain View, CA (US)

(72) Inventors: Zhewen FAN, San Diego, CA (US); Karen C. LO, San Diego, CA (US); Vitor R. CARVALHO, San Diego, CA (US)

(73) Assignee: Intuit Inc., Mountain View, CA (US)

(21) Appl. No.: 16/737,352

(22) Filed: Jan. 8, 2020

(51) Int. Cl. G06N 5/04; G06F 16/2458; G06N 20/20; G06N 5/00

(52) U.S. Cl. CPC G06N 5/04; G06N 5/003; G06N 20/20; G06F 16/2477

(57) ABSTRACT

Systems and methods that may implement an anomaly detection process for time series data. The systems and methods may implement a model ensemble process comprising at least one machine learning model in a supervised class and at least one machine learning model in an unsupervised class.

### BACKGROUND

Anomaly detection is the problem of finding patterns in data that do not conform to a model of “normal” behavior. Typical approaches for detecting such changes either use simple human computed thresholds, or mean and or standard deviations to determine when the data deviates significantly from the mean. However, such simple approaches are not easily adapted to time series data and often lead to the detection of false anomalies, or alternatively, not detecting straightforward anomalies.

Time series may be any data that is associated with time (e.g., daily, hourly, monthly, etc.). Types of anomalies that could occur in times series data may include unexpected spikes, drops, trend changes and level shifts. Spikes may include an unexpected growth of a monitored element (e.g., an increase in the number of users of a system) in a short period of time. Conversely, drops may include an unexpected drop of a monitored element (e.g., a decrease in the number of users of a system) in a short period of time. Trend changes and level shifts are often associated with changes in the data values as opposed to an increase or decrease in the amount of data values.

As can be appreciated, sometimes these changes are valid, but sometimes they are anomalies. Accordingly, there is a need and desire to quickly determine if these are permissible/acceptable changes or if they are anomalies. Moreover, anomaly detection should be performed automatically because in today's world the sheer volume of data makes it practically impossible to tag outliers manually. In addition, it may be desirable that the anomaly detection process be applicable to any time series data regardless of what system or application the data is associated with.

### BRIEF DESCRIPTION OF THE FIGURES

FIG. 1 shows an example of a system configured to detect anomalies in time series data in accordance with an embodiment of the present disclosure.

FIG. 2 shows a server device according to an embodiment of the present disclosure.

FIG. 3 shows an example anomaly detection process according to an embodiment of the present disclosure.

FIG. 4 shows example preprocessing of time series data that may be performed by the anomaly detection process according to an embodiment of the present disclosure.

FIG. 5 shows example model ensemble, training and application that may be performed by the anomaly detection process according to an embodiment of the present disclosure.

FIG. 6 shows example model performance evaluation that may be performed by the anomaly detection process according to an embodiment of the present disclosure.

FIG. 7 shows an example of random forest regression model processing performed according to an embodiment of the present disclosure.

### DETAILED DESCRIPTION OF SEVERAL EMBODIMENTS

Embodiments described herein may be configured to perform an efficient anomaly detection process with respect to time series data. In one or more embodiments, the disclosed principles provide numerous benefits to both the users and maintainers of the data such as e.g., reducing anomaly detection time, identifying pipeline issues and or data bugs proactively.

Embodiments described herein may be configured to perform an automatic anomaly detection process with respect to time series data. In one or more embodiments, the disclosed principles provide numerous benefits to both the users and maintainers of the data such as e.g., reducing anomaly detection time, identifying pipeline issues and or data bugs proactively. In one or more environments, the disclosed principle may be applied to vast amounts of data with distinct patterns and features and thus may be applied to any type of time series data.

In one or more embodiments, the disclosed principles may utilize a new form of model ensemble. For example, the disclosed principles may utilize and combine outputs of two distinct classes of machine learning algorithms/models (e.g., supervised and unsupervised classes). Given the unsupervised nature of anomaly detection problems, the disclosed principles may combine the model classes through an equal weighting scheme and or a simulation based model evaluation process. It should be understood that while model ensembles in anomaly detection may currently exist, none utilize and or combine outputs from both supervised and unsupervised model classes without incurring a significant computational cost.

An example computer implemented method for detecting anomalies in time series data comprises: inputting, at a first computing device and from a first database connected to the first computing device, the time series data; preprocessing the times series data to create a preprocessed time series dataset; splitting the preprocessed time series dataset into a training dataset and a test dataset; and training a plurality of machine learning models using the training dataset. In one embodiment, the machine learning models comprise at least one machine learning model in a supervised class and at least one other machine learning model in an unsupervised class. The method further comprises applying the test dataset to the plurality of machine learning models to obtain an anomaly indicator from each machine learning model; evaluating a performance of the plurality of machine learning models to obtain performance metrics for each machine learning model; and determining an anomaly score for the time series data based on the anomaly indicator from each machine learning model and the performance metrics for each machine learning model.

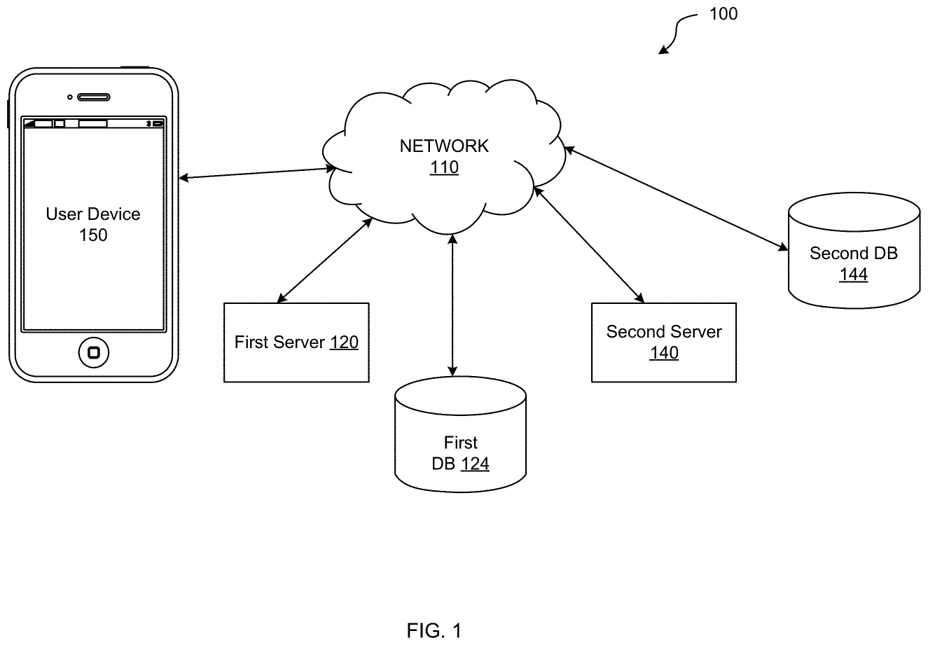

FIG. 1 shows an example of a system 100 configured to detect anomalies in time series data according to an embodiment of the present disclosure. System 100 may include a first server 120, second server 140, and/or a user device 150. First server 120, second server 140, and/or user device 150 may be configured to communicate with one another through network 110. For example, communication between the elements may be facilitated by one or more application programming interfaces (APIs). APIs of system 100 may be proprietary and/or may be examples available to those of ordinary skill in the art such as Amazon® Web Services (AWS) APIs or the like. Network 110 may be the Internet and/or other public or private networks or combinations thereof.

First server 120 may be configured to perform the anomaly detection process according to an embodiment of the present disclosure and may access, via network 110, time series and or other data stored in one or more databases 124, 144 or under the control of the second server 140 and/or user device 150. Second server 140 may include one or more services that may include one or more of financial and or accounting services such as Mint®, TurboTax®, TurboTax® Online, QuickBooks®, QuickBooks® Self-Employed, and QuickBooks® Online, to name a few, each of which being provided by Intuit® of Mountain View Calif. The databases 124, 144 may include the times series and other data required by the one or more services. Detailed examples of the data gathered, processing performed, and the results generated are provided below.

User device 150 may be any device configured to present user interfaces and receive inputs thereto. For example, user device 150 may be a smartphone, personal computer, tablet, laptop computer, or other device.

First server 120, second server 140, first database 124, second database 144, and user device 150 are each depicted as single devices for ease of illustration, but those of ordinary skill in the art will appreciate that first server 120, second server 140, first database 124, second database 144, and/or user device 150 may be embodied in different forms for different implementations. For example, any or each of first server 120 and second server 140 may include a plurality of servers or one or more of the first database 124 and second database 144. Alternatively, the operations performed by any or each of first server 120 and second server 140 may be performed on fewer (e.g., one or two) servers. In another example, a plurality of user devices 150 may communicate with first server 120 and/or second server 140. A single user may have multiple user devices 150, and/or there may be multiple users each having their own user device(s) 150.

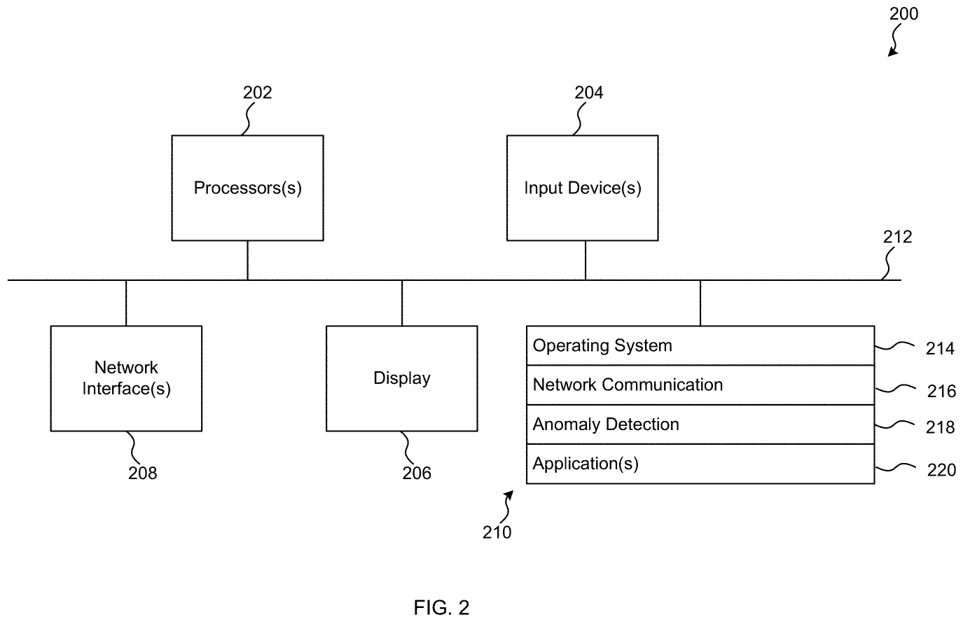

FIG. 2 is a block diagram of an example computing device 200 that may implement various features and processes as described herein. For example, computing device 200 may function as first server 120, second server 140, or a portion or combination thereof in some embodiments. The computing device 200 may be implemented on any electronic device that runs software applications derived from compiled instructions, including without limitation personal computers, servers, smart phones, media players, electronic tablets, game consoles, email devices, etc. In some implementations, the computing device 200 may include one or more processors 202, one or more input devices 204, one or more display devices 206, one or more network interfaces 208, and one or more computer-readable media 210. Each of these components may be coupled by a bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Anomaly detection instructions 218 may include instructions that implement the anomaly detection process as described herein. Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

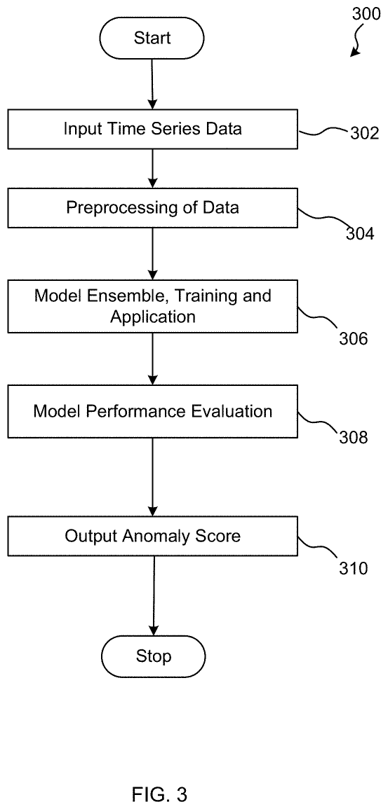

FIG. 3 illustrates an anomaly detection process 300 in accordance with the disclosed principles. In one embodiment, system 100 may perform some or all of the processing illustrated in FIG. 3. For example, first server 120 may be configured to perform the anomaly detection process 300 and may access, via network 110, time series and or other data stored in one or more databases 124, 144 or under the control of the second server 140 and/or user device 150. In one or more embodiments, the process 300 may be performed automatically and may be performed on a periodic basis. In one or more embodiments, the process 300 may be performed on-demand by a specific request by a user or other system application or process to initiate the process 300.

At step 302, the process 300 may input the time series data to be evaluated. In one or more embodiments, the times series data may consist of data from a specific period of time (e.g., a predetermined amount of days, weeks, months, and or years) and frequency of the data (e.g., daily, hourly, minutely). In one or more embodiments, the time series data may contain historical data and new or recent data. In one or more embodiments, the appropriate period of time may be user controlled and may be dictated by a user programmable setting before or when the process 300 is initiated. In one or more embodiments, the appropriate period of time may be a default value set in advance. In one or more embodiments, the time series data may be input and or stored into a table or data structure with each entry consisting of two parts: 1) a data value; and 2) an associated time stamp. In accordance with the disclosed principles, the time stamp may be used to ensure that a data value fits within the period of time the time series data is being evaluated for.

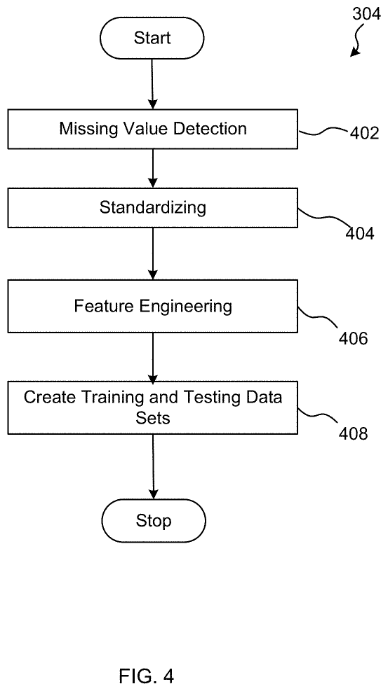

At step 304, the process 300 may preprocess the input data to form a preprocessed time series dataset. In accordance with the disclosed principles, the preprocessing may include a comprehensive set of data quality checks and transformations to ensure the validity of the data for the subsequent model ensemble, training, application and evaluation processes (discussed below). In one or more embodiments, the preprocessing step 304 may be performed in accordance with the example processing illustrated in FIG. 4. For example, at step 402, the input data is examined to determine if there are any missing data values (e.g., an entry with only a time stamp, or an entry with a data value, but no timestamp). In one embodiment, these entries are removed from the preprocessed time series dataset. In one or more embodiments, the processing at step 402 may include normalizing the values through a min-max normalizer, eliminating data values that are too stale (e.g., having timestamps that are before the predetermined evaluation period begins), too recent (e.g., having timestamps that are after the end of the predetermined evaluation period), or insufficient (e.g., missing or out of bounds).

At step 404, the preprocessing 304 may include standardizing time zone information within the timestamps. In one or more embodiments, the standardizing step 404 may include checking for normality and kurtosis of the dataset by performing the well-known Shapiro test. As known in the art, failing the normality test provides a high level of confidence (e.g., 95%) that the data value does not fit within the normal distribution of the dataset. Passing the normality test, however, may indicate that no significant departure from normality was found. In one or more embodiments, other known tests for data normality may be used and the disclosed principles are not limited to the Shapiro test. In one or more embodiments, the data may be transformed for certain normality based algorithms in the subsequent model ensemble step (e.g., step 306).

At step 406, the preprocessing 304 may include feature engineering such as e.g., associating a feature to the data value. In one embodiment, this may include adding another data column to the preprocessed time series data table (or parameter to the data structure if a data structure is used) for the determined feature. In accordance with the disclosed principles, features may be summarized into one of two groups: 1) hot encoded features that may include features such as weekday, weekend, holiday, and or tax-days, to name a few; and 2) time series features such as e.g., rolling windows and lagged values with different lags.

At step 408, the preprocessed dataset may be split into training and testing datasets for use in subsequent steps in the anomaly detection process 300. In one or more embodiments, the preprocessed time series dataset may be split in to any ratio of training data to testing data. In one or more embodiments, the preprocessed time series dataset may be split such that the training dataset is larger than the testing dataset. In one embodiment, the preprocessed time series dataset may be split such that 70% of the data is within the training dataset and 30% of the data is within the testing dataset. It should be appreciated that the disclosed principles should not be limited to how the preprocessed dataset is split into training and testing datasets.

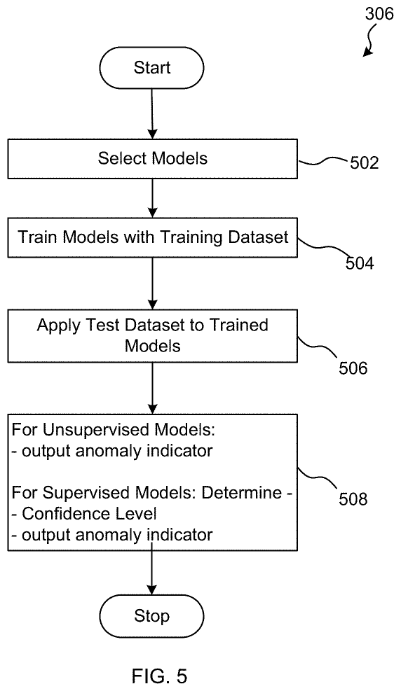

Referring again to FIG. 3, at step 306, the process 300 may perform model ensemble and training. In one or more embodiments, the model ensemble and training step 306 may be performed in accordance with the example processing illustrated in FIG. 5. At step 502, the models to be used may be selected. In one embodiment, the models to be used may be dictated by a user programmable setting before or when the process 300 is initiated. In one or more embodiments, the models to be used may be a default group of models set in advance.

In one or more embodiments, unless the user selects less models, eleven different machine learning models may be selected, trained and used in accordance with the disclosed principles. In one or more of the embodiments, the different models may belong to one of two distinct machine learning classes: supervised and unsupervised classes. The reasons for such an ensemble are two-fold. First, similar models are often correlated, which means when they make wrong decisions, they tend to be wrong simultaneously. This increases model risk. Supervised and unsupervised models are fundamentally different, so they are more likely to make independent model decisions, effectively mitigating the model risk. Second, operationally unsupervised models are extremely fast to train, at the expense of not being able to make a forecast. Supervised models tend to be slower during training, but have the ability to forecast the likely outcome for the test dataset, making their performance assessments more measurable. The disclosed principles balance the trade-offs of each model class and carefully orchestrate the ensemble to achieve a lower model risk, increase operational efficiency and obtain accurate model performance evaluations.

In one or more embodiments, the unsupervised machine learning models may include: Robust PCA, Isolation Forest, Seasonal Adjusted Extreme Student Deviations, Shewhart Mean, Shewhart Deviation, Standard Deviation from the Mean, Standard Deviation from the Moving Average, and Quantiles. In one or more embodiments, the supervised machine learning models may include Random Forest, and SARIMAX. These models are well known and unless otherwise specified herein, each model may be trained and used in the manner conventionally known in the art.

At step 504, the selected models are trained with the training dataset (as determined by step 408 illustrated in FIG. 4). Once trained, the test dataset (as determined by step 408 illustrated in FIG. 4) may be applied to each of the selected models at step 506. At step 508, the outputs of each model may be collected and stored for subsequent evaluation. As noted above, the outputs of the models may be in different forms (e.g., forecasting v. non-forecasting) since a model may be an unsupervised model (e.g., non-forecasting) or a supervised model (e.g., forecasting). There may be a need to account for these differences for the model evaluation process as noted below.

For example, each machine learning model in the unsupervised class may perform various threshold calculations and compare the data in the test dataset to the threshold. Values exceeding the threshold may be marked as an anomaly (e.g., marked as “1”) while other values may be marked as valid (e.g., marked as “0”). Thus, the outputs from the models in the unsupervised class will be an anomaly indicator (e.g., anomaly=1, no anomaly=0).

For each machine learning model in the supervised class, however, the output may be a predicted outcome for the test dataset. This may be different than the anomaly indicator provided by the unsupervised class of models. In accordance with the disclosed principles, a confidence level associated with the supervised model's prediction may be calculated and subsequently used to create an anomaly indicator for the supervised models. In one or more embodiments, the calculation of the confidence level may be critical because with the confidence level, the disclosed principles may then perform a comparison similar to the threshold comparison used with the machine learning models of the unsupervised class. That is, the confidence level may be compared to a threshold confidence level and the output of the comparison may indicate an anomaly (e.g., marked as “1”) when the confidence level exceeds the threshold or valid data (e.g., marked as a “0”) when the confidence level does not exceed the threshold. Thus, in accordance with the disclosed principles, the outputs from the models in the supervised class will also include an anomaly indicator (e.g., anomaly=1, no anomaly=0), which is unique to the disclosed principles.

Referring again to FIG. 3, at step 308, the process 300 may perform model performance evaluation which may aid in determining whether the input time series data has one or more anomalies. For example, at this point in the process 300, the system 100 may have eleven separate anomaly indicators as a result of the model ensemble and training step 306. It may be desirable to determine an overall anomaly score based on those indications. Moreover, it is well-known that the performance of anomaly detection algorithms are hard to assess because anomalies are ad-hoc and not usually labeled. The disclosed principles, however, may circumvent this issue by creating a simulation module that inserts artificially labeled anomalies into a subset of the training dataset so that one or more measures of each model's accuracy can be evaluated based on the simulated data.

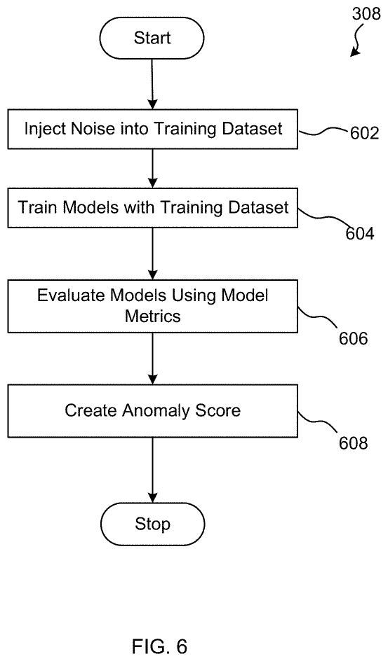

In one or more embodiments, the model performance evaluation step 308 may be performed in accordance with the example processing illustrated in FIG. 6. At step 602, artificially labeled anomalies may be inserted into a subset of the training dataset (as determined by step 408 illustrated in FIG. 4). The insertion of artificially labeled anomalies may also be referred to as injecting noise into the dataset. At step 604, the selected models are trained with the training dataset comprising the artificially labeled anomalies (e.g., as created by step 602). Once trained, at step 606, the models may be evaluated using standard model evaluation metrics such as e.g., precision (i.e., the percentage of the results that are relevant), recall (i.e., the percentage of the total relevant results correctly classified), F1 score (i.e., the harmonic mean of the precision and recall scores), mean squared error (MSE) (i.e., the average squared difference between estimated values and what is estimated), accuracy (i.e., how close the measured value is to the actual value) and or mean absolute error (MAE) (i.e., the average of all absolute errors).

At step 608, an anomaly score may be created using the model anomaly indicators and the performance metrics from the simulation module. In one embodiment, the anomaly score may be determined by creating equal weighted averages of the scores based on the metrics. In one embodiment, the anomaly score may be determined by creating unequally weighted averages of the scores based on the metrics. In one or more embodiments, an anomaly score between 0 and 1 is determined at step 608.

Referring again to FIG. 3, at step 310, the anomaly detection process 300 may output the results of the model performance evaluation to the user or the process that initiated process 300. In one or more embodiments, the output may be an anomaly score between 0 and 1. Depending upon the score, the user of the system 100 may determine that further investigation is required or not. For example, in one embodiment, the closer the anomaly score is to 1, the higher the probability that an anomaly was detected.

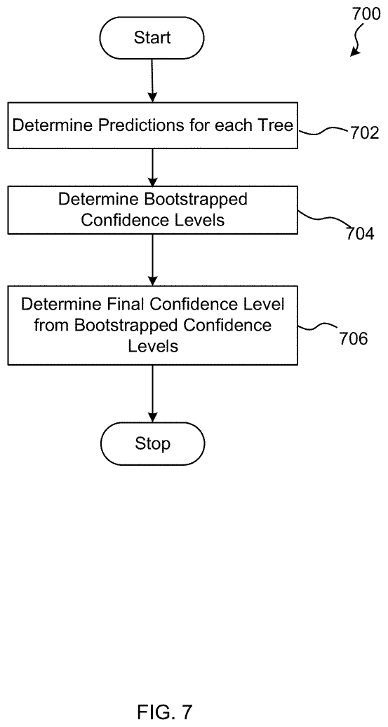

FIG. 7 shows an example of random forest regression model processing 700 performed according to an embodiment of the present disclosure. The disclosed principles may utilize the unique random forest regression model processing 700 because, typically, the regular user of the random forest model is only interested in the model's prediction. However, as noted above, the disclosed principles may calculate a confidence level associated with the prediction for the reasons described above. Thus, in one or more embodiments, a bootstrapping process is performed. For example, for each tree in the forest, a prediction may be determined using a bootstrapping process at 702. At step 704, bootstrapped confidence levels may be determined for each tree as the top and bottom percentiles of the prediction. At step 706, a final confidence level may be determined from an average of the bootstrapped confidence levels determined at step 704. The final confidence level may then be compared to a threshold confidence level to determine an anomaly indicator as described above.

The disclosed embodiments provide several advancements in the technological art, particularly computerized and cloud-based systems in which one device (e.g., first server 120) performs an anomaly detection process that accesses via network 110 time series and or other data stored in one or more databases 124, 144 or under the control of a second server 140 and/or user device 150. For example, the disclosed principles may use the combination of supervised and unsupervised machine learning models in its model ensemble process. The use of both classes of models provides the disclosed principles with advantages of both classes while minimizing their respective short comings. There does not appear to be any anomaly detection process, whether in the appropriate literature or in industry practice, that uses the combination of supervised and unsupervised machine learning models. This alone distinguishes the disclosed principles from the conventional state of the art.

The disclosed principles utilize a novel a bootstrapping confidence level process, which allows the outputs of a Random Forest model to be used with outputs of dissimilar unsupervised models in an evaluation of the time series data in a manner that has not previously existed. In addition, the disclosed principles utilize a simulation-based model performance evaluation process to evaluate and combine anomaly indicators of multiple models to ensure their accuracy and to bypass the need for labeled anomaly tagging. As such, less processing and memory resources are used by the disclosed principles as anomaly labeling is not performed.

Moreover, the disclosed principles are able to create features for each dataset as the models are run, effectively running both training and prediction in as quickly as a couple of seconds. By doing so, the disclosed principles effectively anticipate and mitigate the behavioral shifts that are common in time series data in an acceptable amount of time. As can be appreciated, this also reduces processing and memory resources used by the disclosed principles. As noted above, some of the features of the disclosed principles are customizable by the user. The disclosed principles may expose to the user two hyper-parameters: statistical significance level and the threshold for an anomaly. In doing so, the disclosed principle may leverage the expert opinion from the users who are the most familiar with the datasets they provide.

These are major improvements in the technological art as it improves the functioning of the computer implementing the anomaly detection process and is an improvement to the technology and technical field of e anomaly detection, particularly for large amounts of time series data.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer implemented method for detecting anomalies in time series data, said method comprising:
inputting, at a first computing device and from a first database connected to the first computing device, the time series data;
preprocessing the times series data to create a preprocessed time series dataset;
splitting the preprocessed time series dataset into a training dataset and a test dataset;
training a plurality of machine learning models using the training dataset, the machine learning models comprising at least one machine learning model in a supervised class and at least one other machine learning model in an unsupervised class;
applying the test dataset to the plurality of machine learning models to obtain an anomaly indicator from each machine learning model;
evaluating a performance of the plurality of machine learning models to obtain performance metrics for each machine learning model; and
determining an anomaly score for the time series data based on the anomaly indicator from each machine learning model and the performance metrics for each machine learning model.

2. The method of claim 1, wherein the time series data comprises a plurality of data values with associated timestamps and said preprocessing step comprises:
determining if a timestamp does not fall within a predetermined time period; and
eliminating the data value associated with the timestamp and the timestamp from the preprocessed time series dataset.

3. The method of claim 2, wherein said preprocessing step further comprises:
standardizing the timestamps to a same time zone; and
assigning a feature to each data value, the feature being selected from the group consisting of hot encoded features and time series features.

4. The method of claim 1, wherein obtaining the anomaly indicator for each machine learning model in the supervised class comprises:
outputting a forecast from the machine learning model in the supervised class;
determining a confidence level for the output forecast; and
determining the anomaly indicator for the machine learning model in the supervised class based on a comparison of the determined confidence level to a confidence level threshold.

5. The method of claim 4, wherein the anomaly indicator for each machine learning model in the unsupervised class is obtained based on a comparison of an output of the model to a predetermined threshold.

6. The method of claim 1, wherein evaluating the performance of the plurality of machine learning models to obtain performance metrics for each machine learning model further comprises:
inserting artificially labeled anomalies into a subset of the training dataset;
training the plurality of machine learning models using the subset of the training dataset containing the artificially labeled anomalies; and
evaluating outputs of the models using the obtained performance metrics for each machine learning model.

7. The method of claim 6, wherein the performance metrics comprise one or more of precision, recall, F1 score, mean squared error, accuracy or mean absolute error.

8. The method of claim 1, wherein the at least one machine learning model of the plurality of machine learning models in the supervised class comprises a random forest regression model and the anomaly indicator for the random forest regression model is obtained by a bootstrapping process.

9. The method of claim 8, wherein the bootstrapping process comprises:
outputting a prediction from each tree in the random forest regression model;
determining a bootstrapped confidence level for each tree output;
determining a final confidence level as an average of the bootstrapped confidence levels for each tree output; and
determining the anomaly indicator based on a comparison of the final confidence level to a threshold confidence level.

10. A computer implemented method for detecting anomalies in time series data, said method comprising:
inputting, at a first computing device and from a first database connected to the first computing device, the time series data;
preprocessing the times series data to create a preprocessed time series dataset;
splitting the preprocessed time series dataset into a training dataset and a test dataset;
training a plurality of machine learning models using the training dataset, the machine learning models comprising at least one machine learning model in a supervised class and at least one other machine learning model in an unsupervised class;
applying the test dataset to the plurality of machine learning models to obtain an anomaly indicator from each machine learning model, wherein obtaining the anomaly indicator for each machine learning model in the supervised class comprises:
outputting a forecast from the machine learning model in the supervised class,
determining a confidence level for the output forecast, and
determining the anomaly indicator for the machine learning model in the supervised class based on a comparison of the determined confidence level to a confidence level threshold;
evaluating a performance of the plurality of machine learning models to obtain performance metrics for each machine learning model by:
inserting artificially labeled anomalies into a subset of the training dataset,
training the plurality of machine learning models using the subset of the training dataset containing the artificially labeled anomalies, and
evaluating outputs of the models using the obtained performance metrics for each machine learning model; and
determining an anomaly score for the time series data based on the anomaly indicator from each machine learning model and the performance metrics for each machine learning model.

11. The method of claim 10, wherein the anomaly indicator for each machine learning model in the unsupervised class is obtained based on a comparison of an output of the model to a predetermined threshold.

12. A system for determining an anomaly in time series data, said system comprising:
a first computing device connected to a first database through a network connection, the first computing device configured to:
input the time series data from the first database;
preprocess the times series data to create a preprocessed time series dataset;
split the preprocessed time series dataset into a training dataset and a test dataset;
train a plurality of machine learning models using the training dataset, the machine learning models comprising at least one machine learning model in a supervised class and at least one other machine learning model in an unsupervised class;
apply the test dataset to the plurality of machine learning models to obtain an anomaly indicator from each machine learning model;
evaluate a performance of the plurality of machine learning models to obtain performance metrics for each machine learning model; and
determine an anomaly score for the time series data based on the anomaly indicator from each machine learning model and the performance metrics for each machine learning model.

13. The system of claim 12, wherein the time series data comprises a plurality of data values with associated timestamps and said preprocessing comprises:
determining if a timestamp does not fall within a predetermined time period; and
eliminating the data value associated with the timestamp and the timestamp from the preprocessed time series dataset.

14. The system of claim 13, wherein said preprocessing further comprises:
standardizing the timestamps to a same time zone; and
assigning a feature to each data value, the feature being selected from the group consisting of hot encoded features and time series features.

15. The system of claim 12, wherein obtaining the anomaly indicator for each machine learning model in the supervised class comprises:
outputting a forecast from the machine learning model in the supervised class;
determining a confidence level for the output forecast; and
determining the anomaly indicator for the machine learning model in the supervised class based on a comparison of the determined confidence level to a confidence level threshold.

16. The system of claim 15, wherein the anomaly indicator for each machine learning model in the unsupervised class is obtained based on a comparison of an output of the model to a predetermined threshold.

17. The system of claim 12, wherein said evaluating the performance of the plurality of machine learning models to obtain performance metrics for each machine learning model comprises:
inserting artificially labeled anomalies into a subset of the training dataset;
training the plurality of machine learning models using the subset of the training dataset containing the artificially labeled anomalies; and
evaluating outputs of the models using the obtained performance metrics for each machine learning model.

18. The system of claim 17, wherein the performance metrics comprise one or more of precision, recall, F1 score, mean squared error, accuracy or mean absolute error.

19. The system of claim 12, wherein the at least one machine learning model of the plurality of machine learning models in the supervised class comprises a random forest regression model and the anomaly indicator for the random forest regression model is obtained by a bootstrapping process.

20. The system of claim 19, wherein the bootstrapping process comprises:
outputting a prediction from each tree in the random forest regression model;
determining a bootstrapped confidence level for each tree output;
determining a final confidence level as an average of the bootstrapped confidence levels for each tree output; and
determining the anomaly indicator based on a comparison of the final confidence level to a threshold confidence level.
